(19) United States
(12) Patent Application Publication
(10) Pub. No.: US 2020/0114516 A1
(43) Pub. Date: Apr. 16, 2020

(54) ROBOTIC PERCEPTION EXTENSIBILITY

(71) Applicant: MISTY ROBOTICS, INC., Boulder, CO (US)

(72) Inventors: Christopher Meyer, Boulder, CO (US); Morgan Bell, Boulder, CO (US); Adam Wilson, Boulder, CO (US); Daniel H. Grollman, Boulder, CO (US)

(73) Assignee: MISTY ROBOTICS, INC., Boulder, CO (US)

(21) Appl. No.: 16/160,391

(22) Filed: Oct. 15, 2018

(51) Int. Cl. B25J 9/16; B25J 13/00

(52) U.S. Cl. CPC B25J 9/1694; B25J 13/006; B25J 9/1697

(57) ABSTRACT

Aspects of the present disclosure generally relate to robot perception extensibility. In certain aspects, a robot maintains perception data that represents its understanding of its surroundings. The perception data relates to a variety of objects and comprises information generated by a variety of components, such as sensors and software processes. In order to extend the perception capabilities of the robot, an extensibility interface is provided, which enables an extensibility device to annotate objects and to provide new objects to the robot based on the additional perception data generated by the extensibility device. As a result of incorporating the objects from the extensibility device into the perception data of the robot, the additional perception data of the extensibility device is available to software executing on the robot without requiring the additional effort typically necessary to extend the capabilities of such a device.

### BACKGROUND

A robot typically comprises an array of components that collect and/or generate perception data. The perception data is then used to identify user input, engage with the surroundings of the robot, and/or generate responses to various stimuli, among other uses. However, utilizing an extensibility device to extend the perception data available to the robot may be difficult without first understanding and manipulating low-level aspects of the robot's execution environment.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure generally relate to robot perception extensibility. In certain aspects, a robot maintains perception data that represents its understanding of its surroundings. The perception data relates to a variety of objects and comprises information generated by a variety of components, such as sensors and software processes. In order to extend the perception capabilities of the robot, an extensibility interface is provided, which enables an extensibility device to annotate objects and to provide new objects to the robot, thereby supplementing the perception data available to the robot when generating behaviors.

Accordingly, objects from the perception data of the robot may be provided to the extensibility device, such that the extensibility device may annotate the objects using additional perception data from its components. The annotated objects may then be provided back to the robot, which may incorporate the annotated objects into the perception data of the robot. In another example, the extensibility device may generate new objects based on the additional perception data, which may then be provided to the robot for incorporation into the perception data of the robot. As a result of incorporating the objects from the extensibility device into the perception data of the robot, the additional perception data of the extensibility device is available to software executing on the robot without requiring the additional effort typically necessary to extend the capabilities of such a device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1A depicts an example of a robotic device and various example extensibility devices.

FIG. 1B provides a rear view of the example robotic device and the extensibility device of FIG. 1A.

FIG. 1C depicts a more detailed depiction of an example of the control system in the robot.

FIG. 1D depicts a more detailed depiction of an example of the control system of the extensibility device.

FIG. 2 depicts an example of a method for incorporating perception data from an extensibility device to extend the perception of a robot.

FIG. 3 depicts an example of a method for generating perception data by an extensibility device.

FIG. 4 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

In an example, a robot comprises a variety of components to collect and/or generate perception data, including, but not limited to, distance sensors, depth sensors, capacitive and/or resistive touch sensors, temperature sensors, image or optical sensors, microphones, one or more system processes that generate information, and/or system state information (e.g., battery charge, processor load, etc.). The perception data may be used to determine aspects of the robots behavior, such that the robot generates behaviors and responds to stimuli accordingly. However, using an extensibility device to extend the perception data available to the robot may be difficult without first understanding and modifying various low-level aspects of the robot's execution environment. For instance, a software driver may be needed to enable perception data to be accessed from the extensibility device, system data structures may need to be manually updated based on the perception data from the extensibility device, and, ultimately, the robot may need to be adapted to utilize the perception data provided by the component when generating behaviors.

Accordingly, the present disclosure provides systems and methods for robot perception extensibility. In examples, an extensibility interface is provided to enable a robot to receive or otherwise access perception data from an extensibility device for incorporation into the execution environment of the robot, such that the perception data is available for use by software executing on the robot without requiring any special knowledge of or modification to low-level aspects of the execution environment of the robot. For example, an extensibility device may supplement the preexisting perception data of the robot with additional perception data, including, but not limited to, perception data from a new sensor or set of sensors, as well as from a remote computing device, among other components. In other examples, the robot may analyze the additional perception data from the extensibility device so as to correlate the additional perception data with objects of which the robot is aware. As another example, a robot provides one or more objects to the extensibility device, such that the extensibility device may annotate the objects with additional perception data and return the annotated objects or, in some examples, the extensibility device returns a subset of the additional perception data that corresponds to the one or more provided objects. In an example, the external device generates new objects to provide to the robot.

An extensibility device may communicate with a robotic device using any of a variety of techniques. For example, an extensibility device may utilize a physical connection to communicate with a robotic device, including, but not limited to, an Ethernet connection, a serial connection (e.g., USB, I2C, etc.), or a parallel connection. In another example, a wireless connection is used, such as a Bluetooth or Wi-Fi connection or, in some examples, light-based or audio-based communication is used. In other examples, a robot may communicate indirectly with an extensibility device, such as via an Internet connection and/or via a computing device, among other examples. While example connections and communications are described herein, it will be appreciated that any of a variety of other techniques may be used.

Additionally, it will be appreciated that while example extensibility devices are described herein with respect to physical devices, in some examples an extensibility device may be mainly or purely a software construct. For example, an extensibility device may comprise software executing on a robotic device, such that the software provides additional perception data to one or more processes of the robotic device via an extensibility interface. In another example, the software interfaces with one or more sensors (e.g., local to the robotic device, remote from the robotic device, etc.) and processes data from the sensors according to aspects described herein.

As described above, a robot comprises a variety of components from which perception data is generated. Similarly, an extensibility device comprises one or more components that provide any of a wide variety of additional perception data. In some examples, an extensibility device comprises one or more sensors that are similar to those of a robot, thereby enabling additional perception data to be generated that increases the amount, accuracy, and/or reliability of information available to the robot. In other examples, an extensibility device comprises one or more sensors that generate additional perception data that is different from the perception data already available to the robot. For example, an extensibility device may comprise a thermal camera, thereby enabling a robot that was previously unaware of such temperature information to receive and process temperature information for its surroundings. As another example, an extensibility device may be a device that is remote from the robot, such that the additional perception data received by the robot enables the robot to be aware of an area in addition to its immediate surroundings. For instance, an extensibility device may be an Internet-enabled camera, such that the robot is able to receive a video feed, an audio feed, recognized objects, and/or detected motion from the Internet-enabled camera.

Additional perception data from an extensibility device is incorporated into the perception data of the robot via an extensibility interface, such that it is accessible to software executing on the robot. In an example, the extensibility interface defines a set of functions and/or data structures that enable communication between a robot and an extensibility device without any additional knowledge relating to device capabilities or data types. For example, a robot may provide one or more objects to an extensibility device via the extensibility interface, such that the extensibility device may annotate such objects with additional perception data. In another example, an extensibility device may generate additional perception data and provide the additional perception data to the robot without first receiving such objects from the robot. The robot may then evaluate the additional perception data to annotate objects and generate new objects based on the additional perception data accordingly. In some examples, an extensibility device may provide an indication as to its capabilities and/or the types of objects it is able to annotate, such that the robot may select and provide relevant objects. In other examples, a robot may evaluate annotated objects received from an extensibility device to determine which objects are typically processed and/or generated by the extensibility device, such that the robot may subsequently selectively provide objects that are expected to be annotated by the extensibility device.

An example disposition comprises perception data associated with a time slice of the current state of a robot. The disposition is generated based on input data and output data for the robot. In examples, such data is processed prior to incorporation into the disposition, while, in other examples, raw data may be incorporated into the disposition. For example, image data from a camera is processed to identify one or more world objects, which are then correlated with depth data received from a depth sensor to determine the spatial location of the identified world objects. Thus, a disposition may comprise a set of objects relating to the current state of the robot. Accordingly, additional perception data from an extensibility device may be added to the disposition according to aspects described herein. As used herein, an “object” comprises a set of perception data corresponding to something of which the robot is or can be aware. For example, an object may be a physical thing (e.g., a window, a chair, a location, a person, an animal, a humidity level, etc.), a digital item (e.g., a file, a website, a media stream, a network, etc.), or a perceived or generated item within the environment of the robot (e.g., a “mood,” a fictitious person, animal, or location, etc.), among other examples. As another example, the robot may generate an abstract object, such as an object relating to the weather or the economy, which may be based on data from multiple sources and/or objective or subjective measurements.

Aspects described herein provide a variety of technical benefits. For instance, implementing the disclosed aspects enable the perception capabilities of a device to be more easily extended without first understanding and modifying low-level system aspects of the device. As a result, coding complexity is reduced, as is the potential to introduce security vulnerabilities. Further, user experience is improved, as the user is able to more easily extend the perception capabilities of the device and, as a result of reduced coding complexity, more extensibility devices are likely to be available to the user. Improved extensibility also increases the responsiveness of the device to its surroundings, thereby further improving the user experience offered by a device implementing such aspects. It will be appreciated that while example benefits are described herein, other technical benefits exist as well.

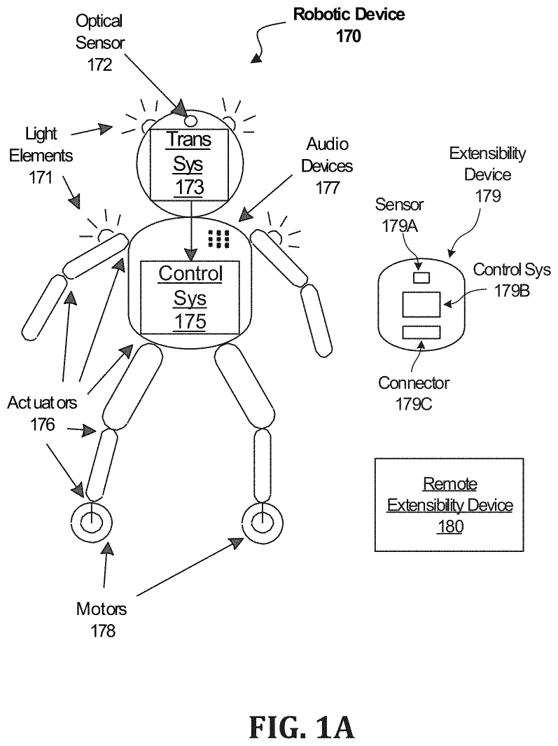

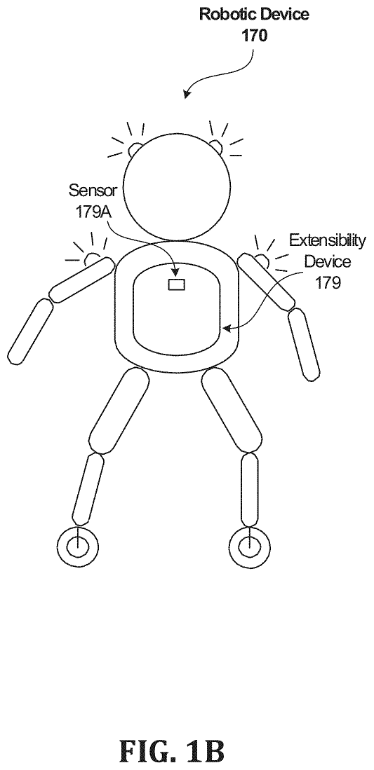

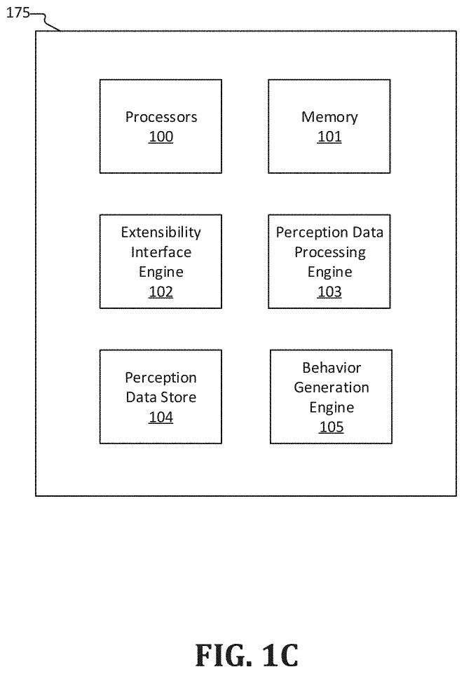

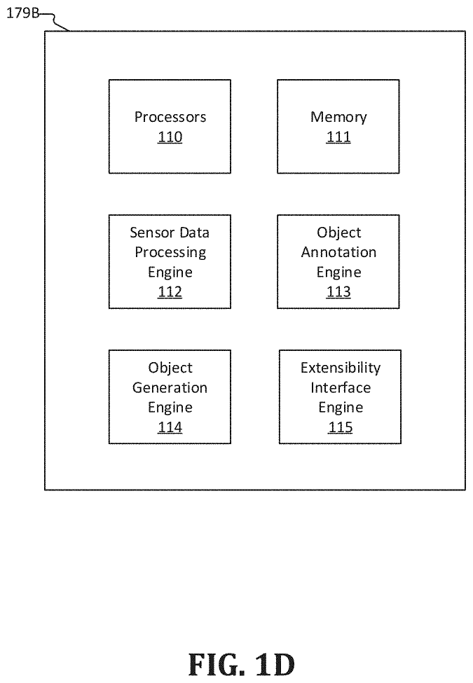

FIG. 1A depicts an example of a robot 170. The terms “robotic device” and “robot” are used interchangeably herein. Further, it will be appreciated that while examples herein are described with respect to a robot, similar techniques may be utilized by any of a wide array of other computing devices, including, but not limited to, personal computing devices, desktop computing devices, mobile computing devices, edge computing devices, and distributed computing devices.

The robot 170 can move in a plurality of manners and can provide feedback through a variety of output mechanisms, so as to convey expressions. For example, the robot 170 may include light elements 171 and audio devices 177. The light elements 171 may include LEDs or other lights, as well as displays for displaying videos or other graphical items. The audio devices 177 may include speakers to provide audio output from the robot 170. A plurality of actuators 176 and motors 178 may also be included in the robot 170 to allow the robot to move as a form of communication or in response to user input. In addition, a plurality of input devices may also be included in the robot 170. For example, the audio devices 177 may also include a microphone to receive sound inputs. An optical sensor 172, such as a camera, may also be incorporated into the robot 170 to receive images or other optical signals as inputs. Other sensors, such as accelerometers, GPS units, thermometers, timers, altimeters, or any other sensor, may also be incorporated in the robot 170 to allow for any additional inputs that may be desired.

The robot 170 may also include a transmission system 173 and a control system 175. The transmission system 173 includes components and circuitry for transmitting data to the robot from an external device and transmitting data from the robot to an external device. Such data transmission allows for programming of the robot 170 and for controlling the robot 170 through a remote control or application on a smartphone, tablet, or other external device. In some examples, inputs may be received through the external device and transmitted to the robot 170. In other examples, the robot 170 may use the transmission system 173 to communicate with an external device over a network (e.g., a local area network, a wide area network, the Internet, etc.). As an example, the robot 170 may communicate with an external device that is part of a cloud computing platform. The control system 175 includes components for controlling the actions of the robot 170. In some examples, the control system 175 comprises components for engaging in robot memory management, according to aspects disclosed herein.

FIG. 1A further comprises extensibility device 179 and remote extensibility device 180. As illustrated, Extensibility device 179 comprises sensor 179A, control system 179B, and connector 179C. In an example, sensor 179A may be any of a variety of sensors, including, but not limited to, a distance sensor, a depth sensor, a capacitive and/or resistive touch sensor, a temperature sensor, an image or optical sensor, or a microphone. It will be appreciated that while extensibility device 179 is described as comprising one sensor 179A, extensibility device 179 may comprise any number and/or types of sensors or other such components in other examples.

Extensibility device 179 also comprises control system 179B, which processes sensor data generated by sensor 179A to generate additional perception data. The additional perception data is provided in a way that conforms to the extensibility interface described herein, such that robot 170 is able to process the additional perception data without first knowing the type of data and/or how the data is formatted. As an example, control system 179B may generate one or more JavaScript Object Notation (JSON) objects relating to the data from sensor 179A. In another example, control system 179B uses Extensible Markup Language (XML) to store the perception data generated based on the sensor data from sensor 179A. While example data structures and techniques are described herein, it will be appreciated that any of a variety of others may be used. In some instances, at least a part of the processing performed by control system 179B may be performed by robotic device 170 (e.g., by control system 175 and/or transmission system 173).

In some examples, control system 179B receives one or more objects from robot 170, such that control system 179B processes the data from sensor 179A to associate the perception data with the objects received from the robot 170. For instance, control system 179B may identify an object having a specific type, an object occupying a specific region of image data, or an object having any of a variety of other attributes, after which the identified object may be annotated using the perception data from sensor 179A. In such examples, control system 179B then provides the objects and/or the processed perception data to robot 170. In other examples, the perception data generated by control system 179B is provided without first receiving one or more objects from the robot 170.

Extensibility device 179 further comprises connector 179C, which may communicatively couple extensibility device 179 to robot 170. As described above, extensibility device 179 may communicate with robot 170 using any of a variety of techniques. For example, connector 179C is a physical connection that can be used to communicate with robot 170, including, but not limited to, an Ethernet connection, a serial connection (e.g., USB, I2C, etc.), or a parallel connection. In other examples, a wireless connection may be used instead of or in addition to connector 179C, such as a Bluetooth or Wi-Fi connection or, in some examples, light-based or audio-based communication is used. For example, connector 179C may provide power to extensibility device 179, while perception data may be communicated to robot 170 via a wireless connection. In another example, a robot may communicate indirectly with an extensibility device, such as via an Internet connection and/or via a computing device, among other examples. While example connections and communications are described herein, it will be appreciated that any of a variety of other techniques may be used.

Remote extensibility device 180 is an extensibility device similar to extensibility device 179, though remote extensibility device 180 is not physically connected to robot 170. For instance, remote extensibility device 180 may be at any of a variety of locations with respect to robot 170. In an example, remote extensibility device 180 may be located in the same room or same house/building as robot 170. In such examples, remote extensibility device 180 and robot 170 may communicate using a local area network (e.g., Ethernet and/or Wi-Fi) or a peer-to-peer connection (e.g., Bluetooth, Wi-Fi Direct, etc.), among others. In another example, remote extensibility device 180 may be located further from robot 170, and may instead be accessible to robot 170 over the Internet. Though extensibility devices 179 and 180 are described as only connecting to robot 170, it will be appreciated that an extensibility device may provide perception data to any number of robotic devices and, similarly, a robotic device may communicate with any number of extensibility devices. Further, as described above, an extensibility device may be, at least in part, a software construct. For example, remote extensibility device 180 may comprise software executing on robotic device 170 and/or a remote computing device, wherein the software provides additional perception data to robotic device 170 for processing via an extensibility interface according to aspects described herein.

FIG. 1B provides a rear view of the example robotic device 170 and extensibility device 179 of FIG. 1A. As illustrated, extensibility device 179 mechanically couples with robot 170. In examples, extensibility device 179 may be coupled with robot 170 using magnets, snap fasteners, one or more slots or tracks, straps, or any of a variety of other coupling mechanisms. In some examples, connector 179C shown in FIG. 1A may be used, at least in part, to mechanically couple extensibility device 179 to robot 170. Sensor 179A is illustrated on either side of extensibility device 179 in FIGS. 1A and 1B. In examples, sensor 179A may be positioned in any of a variety of locations with respect to extensibility device 179 and/or robot 170. In the instant example, extensibility device 179 is provided as a “backpack” for robot 170, such that extensibility device 179 is located on the back of robotic device 170. It will be appreciated that an extensibility device may be placed at any of a variety of locations of a robotic device, including, but not limited to, the head, face, torso, arms, and/or legs of robot 170. It will be appreciated that similar techniques are applicable to robots having any of a variety of other designs.

FIG. 1C depicts a more detailed depiction of an example of the control system 175 in the robot 170. The control system 175 includes one or more processors 100 and a memory 101 operatively or communicatively coupled to the one or more processors 100. The one or more processors 100 are configured to execute operations, programs, or computer executable instructions stored in the memory 101. The one or more processors 100 may be operable to execute instructions in accordance with the robot perception extensibility technology described herein. Memory 101 may be volatile memory (such as RAM), non-volatile memory (such as ROM, flash memory, etc.), or some combination of the two. Memory 101 may comprise computer storage media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. In one example, memory 101 is operable to store instructions for executing methods or operations in accordance with aspects described herein. The instructions may be stored as software or firmware in the control system 175.

The control system 175 also includes an extensibility interface engine 102, a perception data processing engine 103, a perception data store 104, and a behavior generation engine 105. It will be appreciated that the functionality described herein with respect to the control system 175 and other aspects of the robot 170 may be provided at least in part by an external device, in some examples.

In examples, extensibility interface engine 102 enables perception data to be communicated to and from an extensibility device (e.g., extensibility device 179 and/or remote extensibility device 180) according to aspects described herein. For instance, extensibility interface engine 102 may access objects from robot 170 (e.g., from perception data store 104) and provide the objects to the extensibility device. Accordingly, the extensibility device may annotate the provided objects with additional perception data (e.g., based on one or more sensors of the extensibility device, etc.) and provide the annotated objects back to the robot 170 by way of extensibility interface engine 102. In another example, additional perception data (in the form of objects, processed or raw sensor data, etc.) may be received from an extensibility device via extensibility interface engine 102. In some instances, the additional perception data may be received without first providing objects to the extensibility device. In some examples, the additional perception data may be received in the form of one or more objects as described herein, as one or more JSON objects, or using any of a variety of other formats. Extensibility interface engine 102 may provide the perception data received from an extensibility device to perception data processing engine 103.

Perception data processing engine 103 may evaluate received additional perception data to determine pre-existing objects (e.g., as may exist in perception data store 104) with which the perception data should be associated. For example, perception data processing engine 103 may evaluate the additional perception data to determine one or more regions of image data with which the additional perception data is associated, such that objects corresponding to the identified regions may be identified. The additional perception data may then be used to annotate the identified objects accordingly. For instance, objects that were annotated by an extensibility device may replace a pre-existing object in the perception data of robot 170, or differences may be identified and added to the pre-existing object, among other examples. In another example, the received objects may be added to the perception data as new objects. If an object received as part of the additional perception data is not associated with a pre-existing object, the object may be added to the perception data of robot 170 as a new object. Thus, the additional perception data from one or more extensibility devices may be made available to software executing on robot 170. While example processing techniques are described herein, it will be appreciated that other techniques may be used to incorporate additional perception data from an extensibility device into the perception data of robot 170.

Control system 175 is also illustrated as comprising perception data store 104. As described above, perception data store 104 comprises perception data of robot 170. For example, perception data store 104 may store one or more objects, wherein each object may be associated with a subset of the perception data generated by sensors of robot 170, thereby representing the robot's understanding of the world. Similarly, perception data store 104 stores additional perception data that may be received from an extensibility device via extensibility interface engine 102 as described above. In some instances, the perception data and/or objects stored by perception data store 104 may comprise a disposition for robot 170, as is described in greater detail by U.S. patent application Ser. No. 16/123,143, titled “ROBOT MEMORY MANAGEMENT TECHNIQUES,” the entirety of which is hereby incorporated by reference in its entirety.

Behavior generation engine 105 may be used to generate behaviors for robot 170. In an example, the robot's behavior is generated in response to receiving input or based on a current goal for the robot (e.g., an activity that the robot is to perform, resulting from an affective state, etc.), among other reasons. For example, upon receiving input indicative of an interaction with a user, behavior generation engine 105 may determine a response to the received input. In some examples, behavior generation engine 105 accesses perception data from perception data store 104 to determine that a user input was received and/or when determining a response to received input. Accordingly, as a result of incorporating additional perception data from an extensibility device into perception data store 104 as described above, robot 170 is able to process such data when a behavior is generated by behavior generation engine 105. While example robot personality and behavior generation techniques are briefly discussed, it will be appreciated that any of a variety of other techniques may be used. Additional aspects of robot personality and behavior generation are also discussed in U.S. patent application Ser. No. 15/818,133, titled “INFINITE ROBOT PERSONALITIES,” the entirety of which is hereby incorporated by reference in its entirety.

FIG. 1D depicts a more detailed depiction of an example of the control system 179B of the extensibility device 179. The control system 179B includes one or more processors 110 and a memory 111 operatively or communicatively coupled to the one or more processors 110. The one or more processors 110 are configured to execute operations, programs, or computer executable instructions stored in the memory 111. The one or more processors 110 may be operable to execute instructions in accordance with the robot perception extensibility technology described herein. Memory 111 may be volatile memory (such as RAM), non-volatile memory (such as ROM, flash memory, etc.), or some combination of the two. Memory 111 may comprise computer storage media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. In one example, memory 111 is operable to store instructions for executing methods or operations in accordance with aspects described herein. The instructions may be stored as software or firmware in the control system 179B. While control system 179B is described with respect to extensibility device 179, it will be appreciated that similar aspects may be applied to other extensibility devices, such as remote extensibility device 180.

As illustrated, the control system 179B also includes sensor data processing engine 112, object annotation engine 113, object generation engine 114, and extensibility interface engine 115. Similar to extensibility interface engine 102 in FIG. 1C, extensibility interface engine 115 enables extensibility device 179 to receive perception data from and provide perception data to robot 170 according to aspects described herein. For instance, as described above, extensibility interface engine 115 may be used to receive objects from robot 170. Accordingly, extensibility device 179 may annotate the received objects with additional perception data (e.g., using sensor data processing engine 112 and/or object annotation engine 113) and provide the annotated objects back to the robot 170 by way of extensibility interface engine 115. In another example, additional perception data may be provided to robot 170 via extensibility interface engine 115 independent of or without having first received objects from robot 170 (e.g., as may be generated by object generation engine 114 and/or as raw additional perception data from sensor data processing engine 112, among other formats).

Sensor data processing engine 112 processes data from one or more sensors of extensibility device 179 (e.g., sensor 179A, as shown in FIGS. 1A and 1B). As described above, extensibility device 179 may comprise any of a variety of sensors, which may be processed by sensor data processing engine 112 to generate perception data. Example processing includes, but is not limited to, evaluating an analog signal from a sensor to generate one or more digital values based on the analog signal (e.g., a temperature, pressure, and/or humidity reading, etc.), performing speech recognition, and/or using computer vision techniques to identify one or more objects in image data. In examples, the generated perception data is then passed to object annotation engine 113 and/or object generation engine 114. In other examples, at least a part of the perception data may be provided to robot 170 via extensibility interface engine 115 without first generating a new object or annotating an existing object.

As described above, objects may be received from robot 170 via extensibility interface engine 115, which may then be annotated by object annotation engine 113. Perception data may be received from sensor data processing engine 112 and used by object annotation engine 113 to annotate the data of the objects received from robot 170 with the additional perception data generated by sensor data processing engine 112. In some examples, object annotation engine 113 matches at least a subpart of the additional perception data with an object based on any of a variety of factors. Examples include, but are not limited to, a similar spatial region (e.g., occupying a certain region of image data, occupying certain coordinates in the world, etc.) or similar detected characteristics (e.g., similar height, temperature, etc.). In an example, object annotation engine 113 may generate new properties for an object (e.g., add a temperature property, a distance property, etc.) or may supplement or otherwise modify an existing property (e.g., average a pre-existing value based on additional sensor data, add another value to an array, etc.). While example annotation techniques are described, it will be appreciated that other techniques may be used to incorporate additional perception data into an object.

In other examples, object generation engine 114 may generate new objects based on perception data from sensor data processing engine 112. Sensor 179A may be capable of generating data relating to one or more objects of which robot 170 is unaware, such that, rather than annotating an existing object, extensibility device 179 may generate a new object instead. For example, extensibility device 179 may enable robot 170 to sense one or more wireless networks or RFID tags, which may be provided to robot 170 via extensibility interface engine 115 in the form of new objects generated by object generation engine 114. In another example, a remote extensibility device (e.g., remote extensibility device 180) may provide image data (e.g., one or more images, a video feed, etc.) relating to a remote location of which robot 170, sensing its own only its surroundings in some examples, was previously unaware. Image recognition may be used to identify one or more people, animals, or other objects, which may be provided to robot 170 as new objects generated by object generation engine 114. As a result of processing such additional perception data to generate new objects, robot 170 need not be aware of the type, structure, or other attributes/properties associated with the additional perception data, and may instead incorporate the new objects into its own perception data and make such objects available to the software executed by or on behalf of robot 170.

In some examples, an extensibility device need not comprise processors 110 and/or memory 111, such that at least a part of the processing described herein is performed by software. For example, such software may execute on robotic device 170 (e.g., and may be accessed from an extensibility device, from a local or remote data store, etc.) to perform one or more operations described above with respect to control system 179B. As a result, other example extensibility devices may comprise an assortment of sensors or may be a mainly or purely software construct that provides additional perception data to a robotic device via an extensibility interface, among other examples.

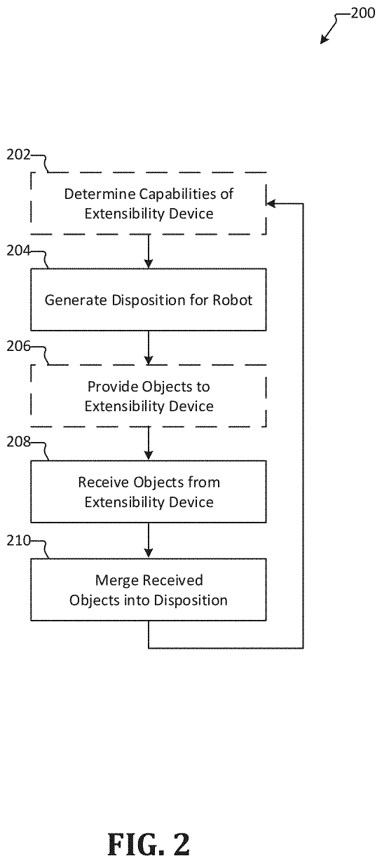

FIG. 2 depicts an example of a method 200 for incorporating additional perception data from an extensibility device to extend the perception of a robot. In an example, aspects of the method 200 are executed or otherwise performed by a robotic device, such as robot 170 in FIG. 1A. Additional perception data may be processed from a local or remote extensibility device according to method 300, such as extensibility device 179 or remote extensibility device 180 in FIG. 1A.

The method 200 begins at operation 202, where the capabilities of an extensibility device are determined. Operation 202 is illustrated in a dashed box to indicate that, in some examples, operation 202 may be omitted from method 200. In examples, capabilities of an extensibility device may be determined based on requesting or accessing capability information from the extensibility device via an extensibility interface, which may indicate, among other things, one or more components of the extensibility device, types of data that may be generated by the extensibility device, one or more types of objects that the extensibility device is capable of annotating, etc. In other examples, capabilities of an extensibility device may be determined based on an analysis of the objects received from the extensibility device and/or an analysis of which objects are typically annotated by the extensibility device, among other examples.

Flow progresses to operation 204, where a disposition is generated for the robot. As described above, a disposition comprises perception data for the robot as may be generated by one or more components (e.g., sensors, information from system processes, state information, etc.). In examples, the disposition is periodically generated and/or is generated in response to the occurrence of an event. While method 200 is described with respect to generating the disposition as operation 204, it will be appreciated that, in other examples, the disposition may be generated separate from method 200 and may instead be generated as part of a separate process, such that the disposition is available for access by method 200.

At operation 206, one or more objects from the disposition are provided to the extensibility device. Similar to operation 202, operation 206 is illustrated using a dashed box to indicate that, in some examples, operation 206 may be omitted from method 200. In examples, the objects may be provided via an extensibility interface engine, such as the extensibility interface engines in FIGS. 1C and 1D. In some examples, all of the objects of the disposition are provided or otherwise made available to the extensibility device. In other examples, a subset of the objects are provided to the extensibility device. In examples where the capabilities of the extensibility device were determined at operation 202, the subset of objects may be selected based on the determined capabilities. In other examples, the subset of objects may be determined based on which types of objects are typically annotated by an extensibility device. While example selection techniques are described herein, it will be appreciated that other techniques may be used to determine which objects to provide to an extensibility device.

Moving to operation 208, one or more objects are received from the extensibility device. In examples where objects are provided to the extensibility device, at least some of the received objects may be objects that were provided to the extensibility device and were annotated accordingly based on the additional perception data of the extensibility device (e.g., using an object annotation engine such as object annotation engine 113 in FIG. 1D). In other examples, at least some of the received objects may be new objects that were generated by the extensibility device, as may be generated by an object generation engine, such as object generation engine 114 in FIG. 1D. Method 200 is described with respect to receiving additional perception data from the extensibility device in the form of one or more objects, but it will be appreciated that, in other examples, at least a part of the additional perception data may be received as processed sensor data (e.g., as may be processed by a sensor data processing engine such as sensor data processing engine 112 in FIG. 1D) or as raw sensor data.

Flow progresses to operation 210, where the received objects are merged into the disposition for the robot. In some examples, merging the objects comprises identifying which objects are new objects and which objects are annotated objects, such that the new objects may be inserted into the disposition and the annotated objects may be merged with the associated pre-existing objects in the disposition. Merging annotated objects may comprise evaluating the one or more annotated objects to identify additional perception data added by the extensibility device and incorporating the additional perception data into an associated existing object in the disposition for the robot. In other examples, an annotated object may be merged by replacing an associated object in the disposition for the robot with the annotated object received from the extensibility device. In some examples, flow terminates at operation 210 while, in other examples, flow returns to operation 202 (or, in examples where operation 202 is omitted, operation 204), such that the disposition of the robot may be continually or periodically updated with new additional perception data from the extensibility device.

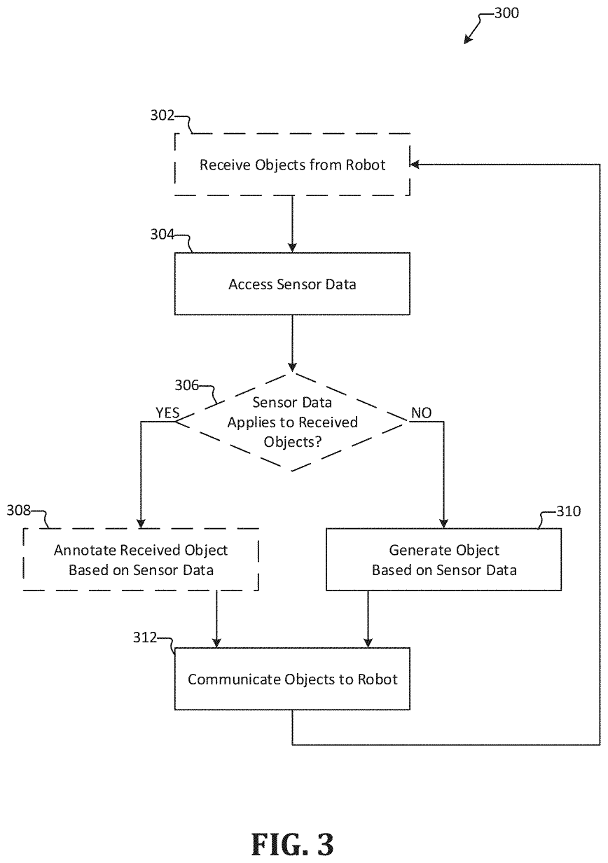

FIG. 3 depicts an example of a method 300 for generating perception data by an extensibility device. In an example, aspects of the method 300 are executed or otherwise performed by an extensibility device, such as extensibility device 179 and/or remote extensibility device 180 in FIG. 1A.

Method 300 begins at operation 302, where objects are received from the robotic device. In an example, the objects are received via an extensibility interface engine, such as extensibility interface engine 102 and/or extensibility interface engine 115 in FIGS. 1C and 1D. In examples, the objects are received as a result of the robotic device performing operation 206 as described above with respect to FIG. 2. Operation 302 is illustrated using a dashed box to indicate that, in some examples, operation 302 may be omitted such that method 300 starts at operation 304.

Flow progresses to operation 304, where sensor data is accessed. In examples, sensor data is accessed from one or more sensors, such as from sensor 179A of extensibility device 179 in FIG. 1A. In some examples, the sensor data is accessed and processed by a sensor data processing engine, such as sensor data processing engine 112 in FIG. 1D. Accordingly, at least a part of the processing described above with respect to the sensor data processing engine may be performed at operation 304. While method 300 is described with respect to data from one or more sensors, it will be appreciated that similar techniques can be used for information from other components.

At determination 306, it is determined whether the data applies to objects received at operation 302. Determination 306 is illustrated using a dashed line to indicate that, in some examples, determination 306 may be omitted from method 300. Determining whether data applies to a received object may be performed using any of a variety of techniques. For example, a region (e.g., of an image, in the world, etc.) may be compared between an object and at least a subpart of the data.

If it is determined that the sensor data applies to a received object, flow branches YES to operation 308, where the received object is annotated based on the data. In an example, annotating the received object is performed by an object annotation engine, such as object annotation engine 113 in FIG. 1D. For example, updating the object comprises updating and/or adding information associated with the object based on the data.

If, however, it is determined that the sensor data does not apply to a received object, flow instead branches NO to operation 310, where a new object is generated based on the data. In an example, generating the new object is performed by an object generation engine, such as object generation engine 114 in FIG. 1D. In examples, operations 308 and 310 are performed contemporaneously, such as in instances where a subpart of the data applies to one or more received objects, whereas another subpart of the data does not apply to the received objects. Further, operations 308 and/or 310 may be performed multiple times, such that multiple objects may be annotated and/or generated based on the data from operation 304.

Flow progresses to operation 312, where the objects annotated and/or generated at operations 308 and/or 310, respectively, are communicated to the robot. In an example, the objects are communicated via an extensibility interface engine, such as extensibility interface engine 102 and/or extensibility interface engine 115 in FIGS. 1C and 1D. Method 300 is described with respect to communicating objects to the robotic device, though it will be appreciated that, in some examples, at least a part of the information communicated to the robotic device may be raw sensor data and/or processed sensor data from one or more sensors of the extensibility device. In an example, method 300 terminates at operation 312. In another example, flow returns to operation 302 or, in some examples, operation 304, such that updated additional perception data is periodically communicated to the robotic device.

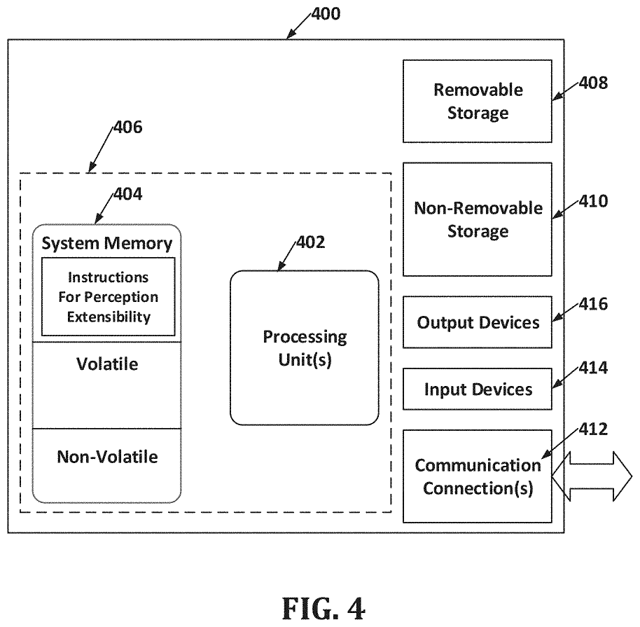

FIG. 4 illustrates another example of a suitable operating environment 400 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 400 typically includes at least one processing unit 402 and memory 404. Depending on the exact configuration and type of computing device, memory 404 (comprising, for example, instructions to perform aspects of the perception extensibility techniques described herein) may be volatile (such as RAM), non-volatile (such as ROM, flash memory, etc.), or some combination of the two. This most basic configuration is illustrated in FIG. 4 by dashed line 406. Further, environment 400 may also include storage devices (removable, 408, and/or non-removable, 410) including, but not limited to, magnetic or optical disks or tape. Similarly, environment 400 may also have input device(s) 414 such as keyboard, mouse, pen, voice input, etc. and/or output device(s) 416 such as a display, speakers, printer, etc. Also included in the environment may be one or more communication connections, 412, such as LAN, WAN, point to point, etc.

Operating environment 400 typically includes at least some form of computer readable media. Computer readable media can be any available media that can be accessed by processing unit 402 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 400 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

As will be understood from the foregoing disclosure, one aspect of the technology relates to a robotic device comprising: at least one processor; and memory encoding computer executable instructions that, when executed by the at least one processor perform a method. The method comprises: receiving, using an extensibility interface, an object comprising perception data from a component of an extensibility device; evaluating the received object to determine whether the object is associated with a pre-existing object of perception data of the robotic device; when it is determined that the received object is associated with a pre-existing object, merging the received object and the pre-existing object; when it is determined that the received object is not associated with a pre-existing object, adding the received object to the perception data of the robotic device; and generating a behavior for the robotic device based on the perception data, wherein the behavior is generated based at least in part on the received object from the extensibility device. In an example, the method further comprises: providing, to the extensibility device, at least one object for annotation. In another example, the received object is determined to be associated with a pre-existing object, and wherein the pre-existing object is one of the at least one object for annotation. In a further example, the method further comprises: selecting, from the perception data of the robotic device, the at least one object for annotation based on capabilities of the extensibility device. In yet another example, the method further comprises: selecting, from the perception data of the robotic device, the at least one object for annotation based on an analysis of at least one object previously received from the extensibility device. In a further still example, the extensibility device is a remote extensibility device, and wherein receiving the object from the extensibility device comprises receiving the object over a network connection. In another example, the robotic device further comprises a coupling means to mechanically couple the extensibility device to the robotic device.

In another aspect, the technology relates to an extensibility device comprising: at least one processor; and memory encoding computer executable instructions that, when executed by the at least one processor, perform a method. The method comprises: receiving, using an extensibility interface, an object comprising perception data from a from a robotic device; generating additional perception data from a sensor of the extensibility device; evaluating the additional perception data to determine whether at least a part of the additional perception data relates to the received object; when it is determined that at least a part of the additional perception data relates to the received object, annotating the received object using the additional perception data to generate an annotated object; and providing, using the extensibility interface, the annotated object to the robotic device. In an example, the method further comprises: receiving a request for capability information from the robotic device; and in response to the request for capability information, providing capability information to the robotic device. In another example, the method further comprises: when it is determined that at least a part of the additional perception data does not relate to the received object, generating a new object based on the at least a part of the additional perception data; and providing, using the extensibility interface, the new object to the robotic device. In a further example, generating the additional perception data comprises processing data from the sensor of the extensibility device. In yet another example, providing the annotated object to the robotic device comprises providing a subpart of the additional perception data that relates to the received object. In a further still example, annotating the received object using the additional perception data comprises performing at least one action selected from the group of actions consisting of: adding at least a part of the additional perception data to the received object; and replacing information of the received object with at least a part of the additional perception data.

In a further aspect, the technology relates to a method for communicating with an extensibility device by a computing device. The method comprises: receiving, using an extensibility interface, an object comprising perception data from a component of the extensibility device; evaluating the received object to determine whether the object is associated with a pre-existing object of perception data of the computing device; when it is determined that the received object is associated with a pre-existing object, merging the received object and the pre-existing object; when it is determined that the received object is not associated with a pre-existing object, adding the received object to the perception data of the computing device; and generating a behavior for the computing device based on the perception data, wherein the behavior is generated based at least in part on the received object from the extensibility device. In an example, the method further comprises providing, to the extensibility device, at least one object for annotation. In another example, the received object is determined to be associated with a pre-existing object, and wherein the pre-existing object is one of the at least one object for annotation. In a further example, the method further comprises selecting, from the perception data of the computing device, the at least one object for annotation based on capabilities of the extensibility device. In yet another example, the method further comprises selecting, from the perception data of the computing device, the at least one object for annotation based on an analysis of at least one object previously received from the extensibility device. In a further still example, the extensibility device is a remote extensibility device, and wherein receiving the object from the extensibility device comprises receiving the object over a network connection. In another example, the computing device is a robotic device.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A robotic device comprising:
at least one processor; and
memory encoding computer executable instructions that, when executed by the at least one processor, perform a method comprising:
receiving, using an extensibility interface, an object comprising perception data from a component of an extensibility device;
evaluating the received object to determine whether the object is associated with a pre-existing object of perception data of the robotic device;
when it is determined that the received object is associated with a pre-existing object, merging the received object and the pre-existing object;
when it is determined that the received object is not associated with a pre-existing object, adding the received object to the perception data of the robotic device; and
generating a behavior for the robotic device based on the perception data, wherein the behavior is generated based at least in part on the received object from the extensibility device.

2. The robotic device of claim 1, wherein the method further comprises:
providing, to the extensibility device, at least one object for annotation.

3. The robotic device of claim 2, wherein the received object is determined to be associated with a pre-existing object, and wherein the pre-existing object is one of the at least one object for annotation.

4. The robotic device of claim 2, wherein the method further comprises:
selecting, from the perception data of the robotic device, the at least one object for annotation based on capabilities of the extensibility device.

5. The robotic device of claim 2, wherein the method further comprises:
selecting, from the perception data of the robotic device, the at least one object for annotation based on an analysis of at least one object previously received from the extensibility device.

6. The robotic device of claim 1, wherein the extensibility device is a remote extensibility device, and wherein receiving the object from the extensibility device comprises receiving the object over a network connection.

7. The robotic device of claim 1, wherein the robotic device further comprises a coupling means to mechanically couple the extensibility device to the robotic device.

8. An extensibility device comprising:
at least one processor; and
memory encoding computer executable instructions that, when executed by the at least one processor, perform a method comprising:
receiving, using an extensibility interface, an object comprising perception data from a from a robotic device;
generating additional perception data from a sensor of the extensibility device;
evaluating the additional perception data to determine whether at least a part of the additional perception data relates to the received object;
when it is determined that at least a part of the additional perception data relates to the received object, annotating the received object using the additional perception data to generate an annotated object; and
providing, using the extensibility interface, the annotated object to the robotic device.

9. The extensibility device of claim 8, wherein the method further comprises:
receiving a request for capability information from the robotic device; and
in response to the request for capability information, providing capability information to the robotic device.

10. The extensibility device of claim 8, wherein the method further comprises:
when it is determined that at least a part of the additional perception data does not relate to the received object, generating a new object based on the at least a part of the additional perception data; and
providing, using the extensibility interface, the new object to the robotic device.

11. The computing device of claim 8, wherein generating the additional perception data comprises processing data from the sensor of the extensibility device.

12. The computing device of claim 8, wherein providing the annotated object to the robotic device comprises providing a subpart of the additional perception data that relates to the received object.

13. The computing device of claim 8, wherein annotating the received object using the additional perception data comprises performing at least one action selected from the group of actions consisting of:
adding at least a part of the additional perception data to the received object; and
replacing information of the received object with at least a part of the additional perception data.

14. A method for communicating with an extensibility device by a computing device, comprising:
receiving, using an extensibility interface, an object comprising perception data from a component of the extensibility device;
evaluating the received object to determine whether the object is associated with a pre-existing object of perception data of the computing device;
when it is determined that the received object is associated with a pre-existing object, merging the received object and the pre-existing object;
when it is determined that the received object is not associated with a pre-existing object, adding the received object to the perception data of the computing device; and
generating a behavior for the computing device based on the perception data, wherein the behavior is generated based at least in part on the received object from the extensibility device.

15. The method of claim 14, further comprising:
providing, to the extensibility device, at least one object for annotation.

16. The method of claim 15, wherein the received object is determined to be associated with a pre-existing object, and wherein the pre-existing object is one of the at least one object for annotation.

17. The method of claim 15, further comprising:
selecting, from the perception data of the computing device, the at least one object for annotation based on capabilities of the extensibility device.

18. The method of claim 15, further comprising:
selecting, from the perception data of the computing device, the at least one object for annotation based on an analysis of at least one object previously received from the extensibility device.

19. The method of claim 14, wherein the extensibility device is a remote extensibility device, and wherein receiving the object from the extensibility device comprises receiving the object over a network connection.

20. The method of claim 14, wherein the computing device is a robotic device.
